(19) United States
(12) Patent Application Publication
(10) Pub. No.: US 2026/0290927 A1
(43) Pub. Date: Sep. 24, 2026

(54) SYSTEMS AND METHODS FOR USING REPURPOSED BATTERIES

(71) Applicant: Nextpower LLC, Fremont, CA (US)

(72) Inventors: Nathan James Malone, Fremont, CA (US); Bethany Ramadan, Fremont, CA (US); Harry Van, Oakland, CA (US); Alexander W. AU, Oakland, CA (US)

(21) Appl. No.: 19/562,164

(22) Filed: Mar. 10, 2026

Related U.S. Application Data
(60) Provisional application No. 63/774,335, filed on Mar. 19, 2025.

(51) Int. Cl. H01M 10/54; H01M 10/42; H01M 50/244; H02J 7/35; H02J 7/44; H02J 7/70; H02J 7/90

(52) U.S. Cl. CPC H01M 10/54; H01M 10/425; H01M 50/244; H02J 7/35; H02J 7/44; H02J 7/751; H02J 7/933; H01M 2010/4271; H01M 2010/4278; H02J 2207/20

(57) ABSTRACT

Systems and methods for charging repurposed batteries include a plurality of casings housing one or more batteries, each of the one or more batteries being uncased. Each casing having externally facing connections of DC+, DC−, and one or more data communications links, each coupled to internally facing connections to DC+, DC−, and one or more data communications links associated with the one or more batteries housed in such casing. A battery charging rack having a plurality of compartments, each compartment configured to hold one of the plurality of casings for charging the one or more batteries housed in such casing. The battery charging rack having a common bus operatively coupled to the one or more communication links in each compartment for providing communication from each compartment to a controller, the battery charging rack selectively providing electrical voltage to one or more compartments based on instructions from the controller.

### RELATED APPLICATIONS

This application claims the benefit of U.S. Provisional Patent Application No. 63/774,335, filed Mar. 19, 2025, the entire contents of which are incorporated herein by reference.

### TECHNICAL FIELD

This disclosure relates generally to solar power generation systems, and more particularly, to using repurposed battery systems for use within solar power generation systems and components associated therewith.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

As can be appreciated, solar tracker systems and components associated therewith, such as, vehicles associated with solar tracker system parts delivery and assembly, and vehicles associated with cleaning solar tracker systems (e.g., robotic vehicles), require power to operate. In some cases, the solar tracker system components may be fully battery-operated. In other cases, the solar tracker system components may be battery-assisted. Depending on the scope and size of the application calling for mobile devices running on battery power, the expense of the batteries can be significant. To mitigate the high cost of the batteries, one might consider acquiring batteries of different size, capacity, voltage, or chemistry, including new, used, and/or repurposed batteries if such batteries were less expensive than using a large number of the same type of batteries. Using such a variety of batteries may be seen as impractical. Different batteries require different dedicated chargers and different connections to the mobile devices they power. As such, the cost and logistics associated with relying on different types of batteries for a common application within the solar tracker system is impractical.

### SUMMARY

In general, the present disclosure relates to support structures for solar arrays within a solar tracking system. In one example, a system for charging repurposed batteries may include a plurality of casings, each casing being of consistent size and housing one or more batteries. Each of the one or more batteries being uncased, whereby an original casing of the one or more batteries may have been removed, each casing having externally facing connections of DC+, DC−, and one or more data communications links, the externally facing connections each coupled to internally facing connections to DC+, DC−, and one or more data communications links associated with the one or more batteries housed in such casing. A battery charging rack may have a plurality of standardized sized compartments, each compartment sized to hold one of the plurality of standardized sized casings for charging the one or more batteries housed in such casing, each compartment having connections for DC+, DC−, and one or more data communications links positioned and shaped to for interconnection with the DC+, DC−, and one or more data communications links of the one of the plurality of standardized casings when held in such compartment, the battery charging rack having a common bus operatively coupled to the one or more communication links in each compartment for providing communication from each compartment to a controller, the battery charging rack selectively providing electrical voltage to the DC+ and DC− connections of select one or more compartments based on instructions from the controller.

Additionally or alternatively, the one or more batteries housed in one of the plurality of casings have different manufacturers, different battery max voltages or different battery charging currents.

Additionally or alternatively, each casing may include a battery management system to manage the one or more batteries housed in such casing.

Additionally or alternatively, each casing may include a battery interface controller configured to store information about an associated one of the one or more batteries housed in the casing.

Additionally or alternatively, the information stored by the battery interface controller may include one or more of: a battery manufacturer, a battery max voltage, and a battery current.

Additionally or alternatively, the externally facing connection of the one or more data communications links of each casing may be connected to both the battery management system and the battery interface controller, the battery interface controller configured to allow the battery management system to communicate directly with the battery charging rack via the one or more communication links of such casing.

Additionally or alternatively, the battery management system and the battery interface controller may be in series such that the battery management system connects through the battery interface controller to the externally facing connection of the one or more data communications links of each casing, the battery interface controller acting as a translator between the battery management system and the battery charging rack.

Additionally or alternatively, the one or more batteries may include a first battery and a second battery and the battery management system includes a first battery management system and a second battery management system, the first battery being associated with the first battery management system, and the second battery being associated with the second battery management system, the battery interface controller acting as a multiplexor to selectively transmit data between the first battery management system or the second battery management system and the externally facing connection of the more or more communication links of each case.

Additionally or alternatively, the one or more batteries may include a first battery and a second battery and the battery management system includes a first battery management system and a second battery management system, the first battery being associated with the first battery management system, and the second battery being associated with the second battery management system, each of the first battery management system and the second battery management system connected to the externally facing connection of the more or more communication links of each case.

Additionally or alternatively, the one or more data communications links of the battery rack may include a battery management system CAN BUS communication link, and a battery interface controller communication link.

In another example, a method of repurposing rechargeable batteries may include removing a battery from an original casing of the battery, placing the battery within a standardized sized casing, connecting a DC+, a DC−, and one or more data communications links of the battery to externally facing connections of DC+, DC−, and one or more data communications links of the standardized size casing, placing the standardized battery casing within a standardized compartment of a battery charging rack, communicating with the battery in the battery charging rack via the one or more data communication links of the casing to determine battery charge parameters, and charging the battery via the charging rack in accordance with the determined battery charge parameters.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a schematic, top view of a battery charging rack, in accordance with the present disclosure;

FIG. 2A is a schematic, top view of a casing including a battery with a battery management system and a battery interface controller in parallel, in accordance with the present disclosure;

FIG. 2B is a schematic, top view of the casing including the battery, as in FIG. 2A, with the battery management system and the battery interface controller in series, in accordance with the present disclosure;

FIG. 3 is a schematic, top view of the casing including a battery, in accordance with the present disclosure;

FIG. 4A is a schematic, top view of the casing including two batteries shown in parallel, in accordance with the present disclosure;

FIG. 4B is a schematic, top view of the casing including the two batteries, as in FIG. 4A, shown in series, in accordance with the present disclosure;

FIG. 5A is a schematic, top view of an example casing including a battery, in accordance with the present disclosure;

FIG. 5B is a schematic, top view of another example casing including a battery, in accordance with the present disclosure;

FIG. 5C is a schematic, top view of yet another example casing including a battery, in accordance with the present disclosure;

FIG. 6 is a schematic, block diagram illustrating a battery charging rack system, in accordance with the present disclosure;

FIG. 7 is a flow chart illustrating a method of charging batteries within a battery charging rack, in accordance with the present disclosure;

FIG. 8A depicts sequential charging of batteries within a battery charging rack in accordance with the present disclosure; and

FIG. 8B depicts simultaneous charging of batteries within a battery charging rack in accordance with the present disclosure.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to providing power to components associated with solar tracker systems, such as, vehicles associated with solar tracker system parts delivery and assembly, and vehicles associated with cleaning solar tracker systems (e.g., robotic vehicles). To mitigate the high cost of the batteries, one might consider acquiring batteries of different size, capacity, voltage, or chemistry, including new, used, and/or repurposed batteries, however, differing batteries may require different dedicated chargers and different connections to the mobile devices they power. While the use of differing batteries for a common application may be impractical, embodiments disclosed herein can be configured to provide standardized casings and charging systems and methods thereof for batteries of varying sizes capacity, voltage, or chemistry.

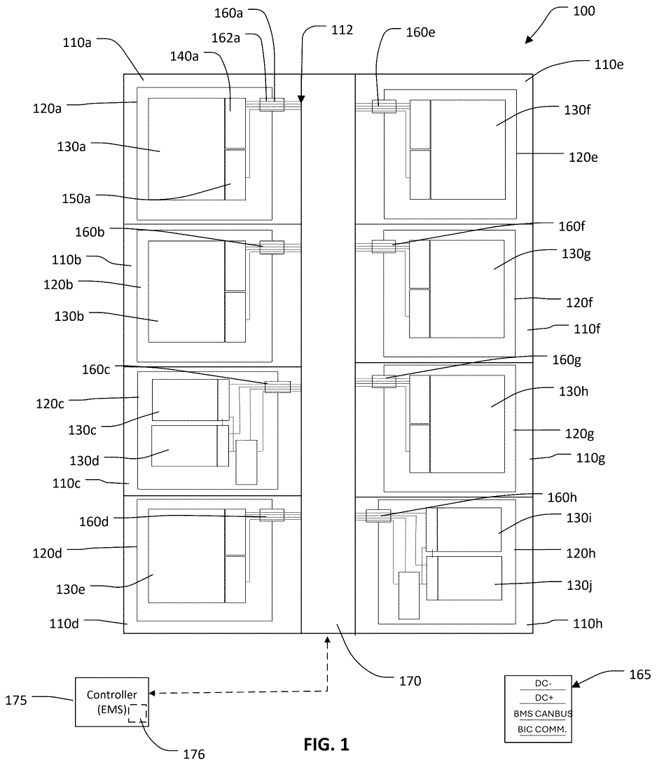

FIG. 1 is a schematic, top view of a battery charging rack 100 in accordance with the present disclosure. The battery charging rack 100 may be configured with one or more standardized compartments 110a, 110b, 110c, 110d, 110e, 110f, 110g, 110h, generally referred to herein as compartments 110. The compartments 110 may be configured to house a plurality of casings 120a, 120b, 120c, 120d, 120e, 120f, 120g, 120h, generally referred to herein as casings 120. The casings 120 may be standardized battery casings 120 each having a consistent form factor (e.g., size) such that the casings 120 uniformly fit within the compartments 110 of the battery charging rack 100. In some examples, each compartment 110 may include a complementary shape and size to hold one of the plurality of casings 120. In some examples, the compartments 110 of the battery charging rack 100 may be the same size. In other examples, the compartments 110 of the battery charging rack 100 may vary in size. Each one of the compartments 110 may include connections 112 for DC+, DC−, and one or more data communications links, such as a battery management system (BMS) CAN BUS communication, and a battery interface controller (BIC) communication, positioned and shaped for interconnection with DC+, DC−, and one or more data communications links of the one of the plurality of casings when held in such compartment, as will be described further herein.

The casings 120 may be configured to house one or more batteries 130a, 130b, 130c, 130d, 130e, 130e, 130g, 130h, 130i, 130j, generally referred to herein as batteries 130. The batteries 130 may vary in size, capacity, voltage, or chemistry. For example, the batteries 130 may be batteries that are removed from an original manufacturer casing and repurposed by placing them within the casings 120 enclosed via adhesives, screws, or any other suitably type of coupling mechanism. The casings 120 may be configured to provide a uniform casing for each battery of the batteries 130 irrespective of the size, capacity, voltage, or chemistry of each battery. The battery charging rack 100 may then be configured to charge the batteries 130 positioned therein, as will be discussed herein. In some examples, the multiple connected batteries 130 may act as large energy storage for on-site renewable sources. In other examples, the batteries 130 may be removable, and may be configured for use in field machines (e.g., robots, tools, etc.).

Each of the batteries 130 may be associated with a battery management system (BMS) 140a. The BMS 140a may remain intact from its associated battery (e.g., battery 130a in this example) of the batteries 130 and may be positioned within the casings 120 with the associated battery of the batteries 130. Each BMS 140a may be responsible for monitoring, sensing, and controlling the associated battery of the batteries 130 during charge and/or discharge of the battery. The BMS 140a may require proprietary information to interpret data received from the battery charging rack 100 for the associated battery (e.g., battery 130a). Further, a battery interface controller (BIC) 150a may be positioned within each of the casings 120. The BIC 150a may be configured to store information about the battery (e.g., battery 130a in this example) such as, for example, the manufacturer, a max voltage, a current, etc.

The battery charging rack 100 may further include a common bus 170. The common bus 170 may be a CAN BUS that may be operatively coupled to an external central controller 175 via a wireless or wired communication. The common bus 170 may send and/or receive communications (e.g., commands, data) to and/or from the controller 175. For example, the common bus 170 may be operatively coupled to the one or more communication links in each compartment 110 for providing communication from each compartment 110 to the controller 175. Throughout this disclosure, when referring to “a/the controller” or “one or more controllers”, it will be understood that any number of controllers can be used and that the controller(s) can be configured to perform the described action. Further, the term “controller” is to be given its broadest reasonable interpretation that at least encompasses a processor in communication with a memory 176 storing instructions that, when executed by the processor, cause the processor to perform a described function.

In some examples, the controller 175 may be an energy management system (EMS). The controller 175 may be in communication with multiple battery charging racks (e.g., battery charging rack 100) at a solar tracker system site. It may be contemplated that a solar tracker system site may include one battery charging rack, two battery charging racks, ten battery charging racks, twenty battery charging racks, or any other suitable number of battery charging racks, as desired. In some examples, the controller 175 may include the memory 176 that may store instructions thereon configured to instruct the common bus 170 to control an applied voltage and a current to each of the casings 120 based on a charge schedule. The controller 175 may further be configured to communicate with a power source, such as a solar power plant, and provide power to the battery charging rack 100 via the common bus 170.

Referring to the casings 120, the casings 120 may each be fitted with one or more externally facing connections 160a, 160b, 160c, 160d, 160e, 160f, 160g, 160h, generally referred to herein as connections 160. The connections 160 may be operatively coupled to the common bus 170 of the battery charging rack 100 and may further be configured to be coupled to internally facing connections 162 associated with the batteries 130 housed within the casings 120. While varying batteries 130 may require different charges and/or connections, the connections 160, which may be standardized, may be configured to couple each of the respective batteries 130 to the common bus 170. The connections 160 and the internally facing connections 162 may each house at least four connections for each of the batteries 130, such as, for example, a DC+, a DC−, and one or more data communication links, such as a battery management system (BMS) CAN BUS communication, and a battery interface controller (BIC) communication, as referenced by block 165. The connections 160 may further be coupled to the common bus 170 of the battery charging rack 100. As stated, the controller 175 may include the memory 176 that may store instructions thereon configured to instruct the common bus 170 to control the applied voltage and current to each of the casing 120 based on a charge schedule. For example, the common bus 170 may be configured to distribute power to each of the batteries 130 based on the charge schedule and battery charge limitations for each of the batteries 130 housed within the battery charging rack 100. In such examples, the battery charging rack 100 may selectively provide an electrical voltage to the DC+ and DC− connections of a select one or more of the compartments 110 based on instructions from the controller 175. The common bus 170 may be configured to charge the batteries 130 via the connections 160 and the internally facing connections 162. The BIC 150a may be added to the casings 120 to aid in communication between the common bus 170 and the BMS 140a.

In some examples, an onboard battery ID may be used to determine a required BUS communication protocol, which may be data used to create a local battery manifest (LBM) for the battery charging rack 100. The LBM may include information such as: a list of batteries coupled to the battery charging rack 100 (e.g., each of the batteries 130 serial numbers, manufacturers), as well as each of the batteries 130 power (e.g., voltage) and charge status information (e.g., voltage communication protocol). The BUS communication protocol may be used to convert charge information for each of the batteries 130 into a readable format via the BIC 150a. Battery data storage may store condensed charge history and battery ID, and the battery ID may be validated with a database stored within the BIC 150a prior to charging.

The battery charging rack 100 described with reference to FIG. 1 may be used within a solar tracker system and may be configured to charge differing batteries 130 typically requiring differing dedicated chargers in a standardized manner for a plurality of solar tracker components and/or equipment associated therewith. While one battery charging rack 100 is described, it may be contemplated that there may be multiple battery charging racks 100 per solar tracker site, wherein each of the multiple battery charging racks 100 share a singular power source, or each of the multiple battery charging racks 100 has its own independent power source.

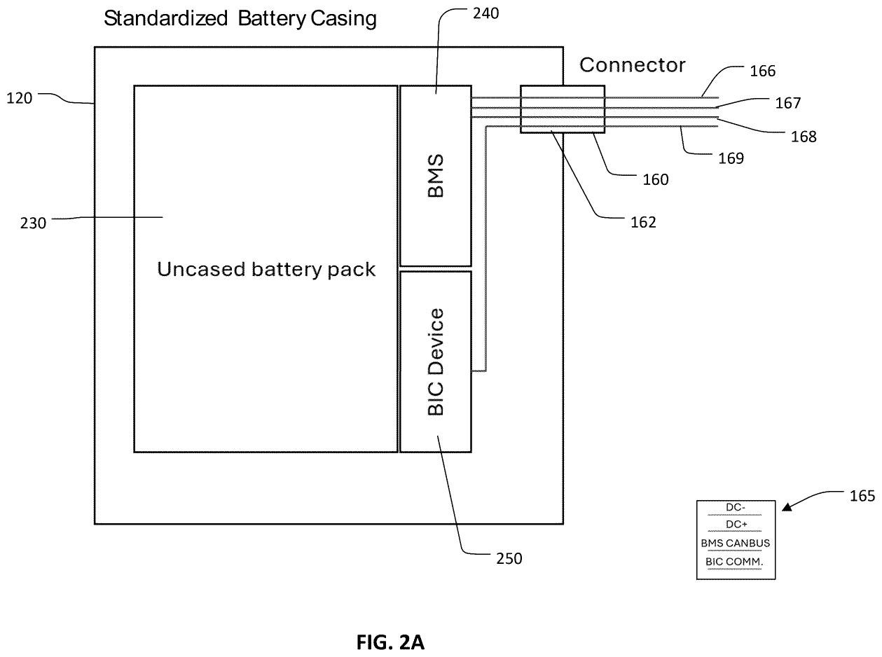

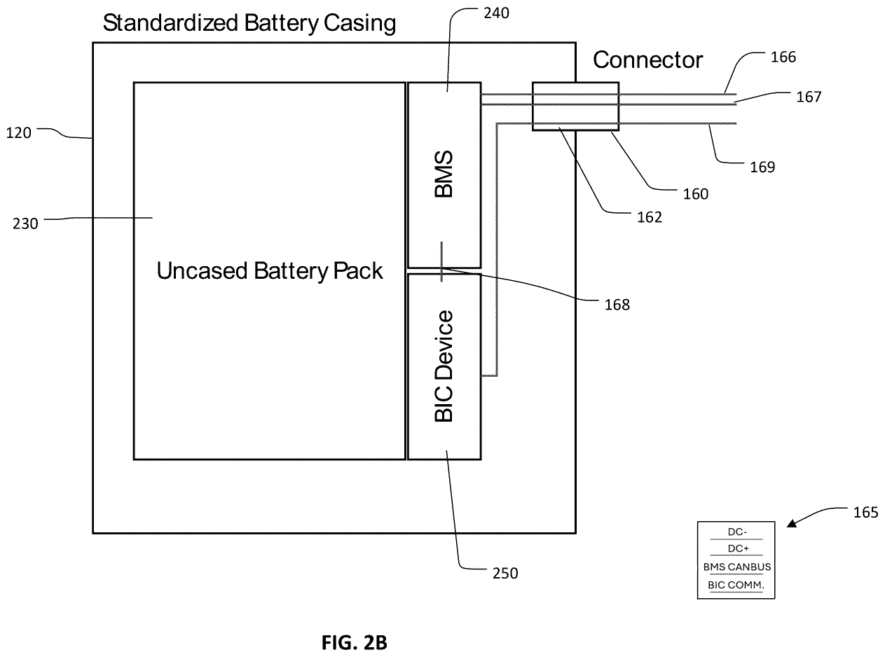

FIG. 2A is a schematic, top view of the casing 120 including a battery 230 with a battery management system (BMS) 240 and a battery interface controller (BIC) 250 in parallel, and FIG. 2B is a schematic, top view of the casing 120 including the battery 230, as in FIG. 2A, with the BMS 240 and the BIC 250 in series. The casing 120 may be configured to be positioned within a battery charging rack (e.g., battery charging rack 100, as in FIG. 1). In some examples, the casing 120 may be intentionally oversized to allow for various battery form factors while maintaining a final shape and size that is similar to or the same as each casing 120 held within compartments of the battery charging rack. In some examples, the casing 120 may be different in size from each casing 120 held within compartments of the battery charging rack.

The battery 230 may be removed from its original casing (e.g., manufacturer casing). The battery 230 may then be placed within a new casing, such as casing 120 consistent with form factor, and attached thereto using adhesives, screws, or any other suitable type of coupling mechanism as desired. The battery management system (BMS) 240 corresponding to the battery 230 may be kept intact from the respective original casing. The BMS 240 may be responsible for monitoring, sensing, and controlling the battery 230 during charge and/or discharge. Further, the BMS 240 may include proprietary information to interpret data received from and sent to an energy management system (EMS), as discussed elsewhere herein.

The battery interface controller (BIC) 250 may be placed in the casing 120, and may be configured to store information about the respective battery 230, such as, for example, the manufacturer, the max voltage, the current, etc. The BIC 250 may be powered by the respective battery 230 in the casing 120. The BIC 250 may need information on BUS communication protocol. For example, as described elsewhere herein, an onboard battery ID may be used to determine a required BUS communication protocol, which may be data used to create a local battery manifest (LBM) for the battery charging rack (e.g., battery charging rack 100). The BUS communication protocol may be used to convert charge information for the battery 230 into a readable format via the BIC 250. Battery data storage may store condensed charge history and battery ID, and the battery ID may be validated with a database stored within the BIC 250 prior to charging.

As shown in FIGS. 2A and 2B, the casing 120 may include the connections 160. The connections 160 is described herein with reference to FIG. 1. The connections 160 and the internally facing connections 162 may house at least four connections for the battery 230, such as, for example, a DC− 166, a DC+ 167, a battery management system (BMS) CAN BUS communication 168, and a battery interface controller (BIC) communication 169, as further referenced by block 165.

As shown in FIG. 2A, the BMS 240 and the BIC 250 are in parallel. In such examples, the BIC 250 supplies information for the BMS communication protocol and further allows the BMS 240 to communicate directly with the battery charging rack (e.g., battery charging rack 100). As shown in FIG. 2B, the BMS 240 and the BIC 250 are in series. In such examples, the BMS 240 communicates with the battery charging rack through the BIC 250, whereas the BIC 250 acts as a translator between the battery charging rack and the BMS 240.

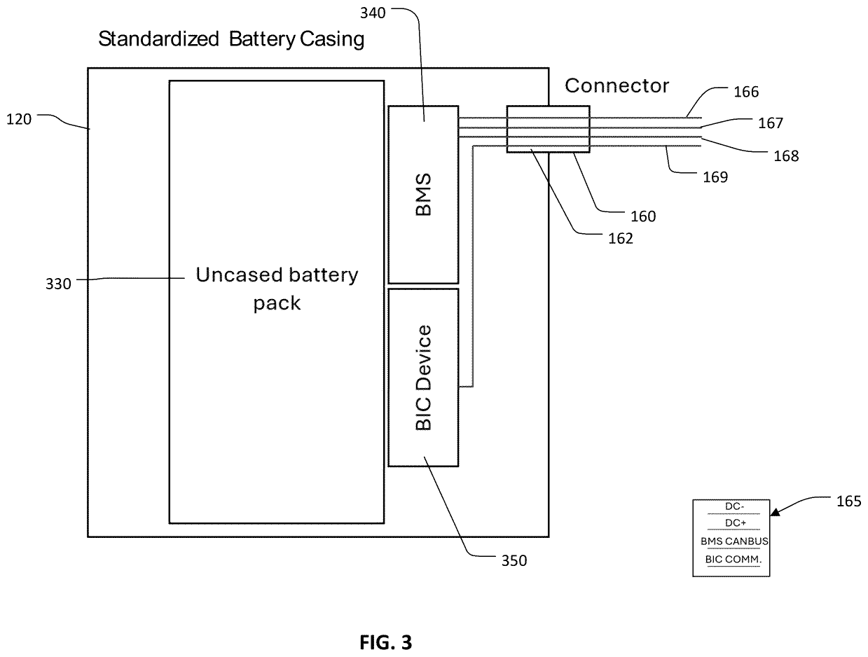

FIG. 3 is a schematic, top view of the casing 120 including another example battery 330. The casing 120 including the battery 330 shown in FIG. 3 is like the casing 120 including the battery 230 described with reference FIGS. 2A and 2B, however, the size of the battery 330 differs from that of the battery 230.

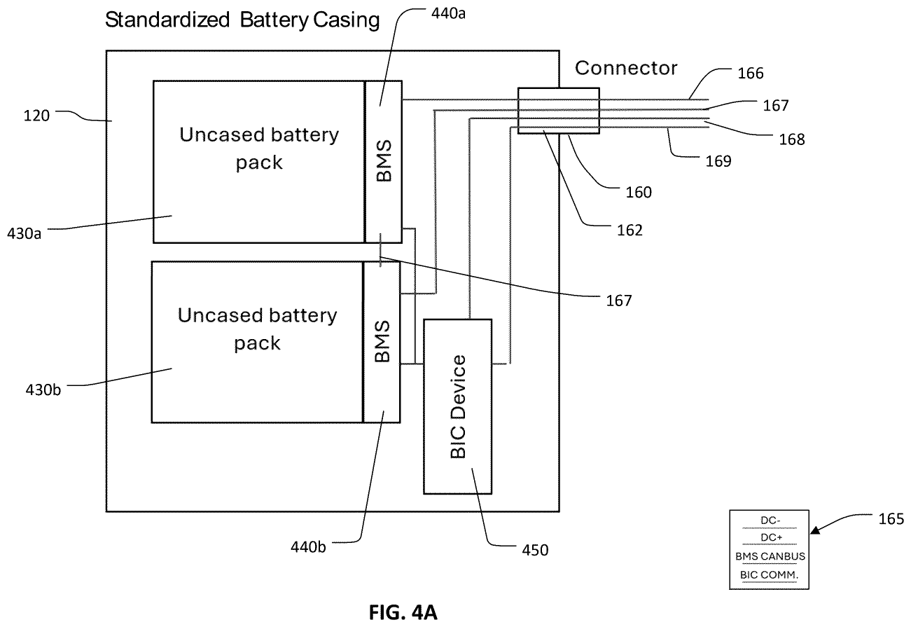

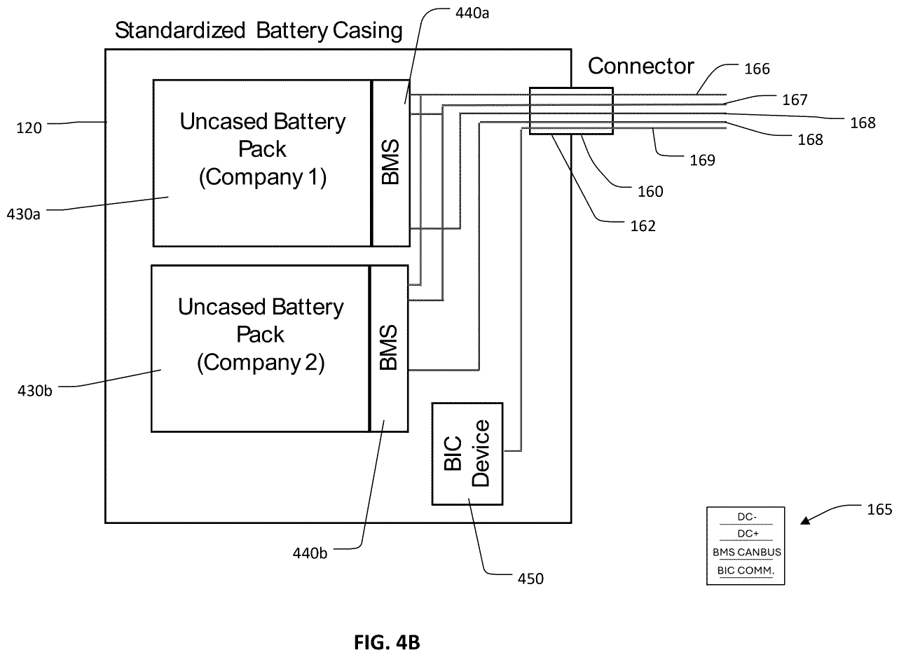

FIG. 4A is a schematic, top view of the casing 120 including a first battery 430a and a second battery 430b shown in parallel, and FIG. 4B is a schematic, top view of the casing 120 including the first battery 430a and the second battery 430b, as in FIG. 4A, shown in series. The casing 120 including the batteries 430a, 430b shown in FIGS. 4A and 4B is like the casing 120 including the battery 230 described with reference FIGS. 2A and 2B, however, as shown in FIGS. 4A and 4B, multiple smaller batteries, such as the first battery 430a and the second battery 430b, may be connected in series or in parallel to make a single “larger battery” within the casing 120. In such examples, the BIC 450 may act as a multiplexer configured to aggregate BMS 440 outputs and mimic inputs. Further, BMS CAN BUS communication 168 connections allow for direct connection to multiple batteries 430a, 430b. In some examples, the BIC 450 stores information of all internal batteries 430a, 430b.

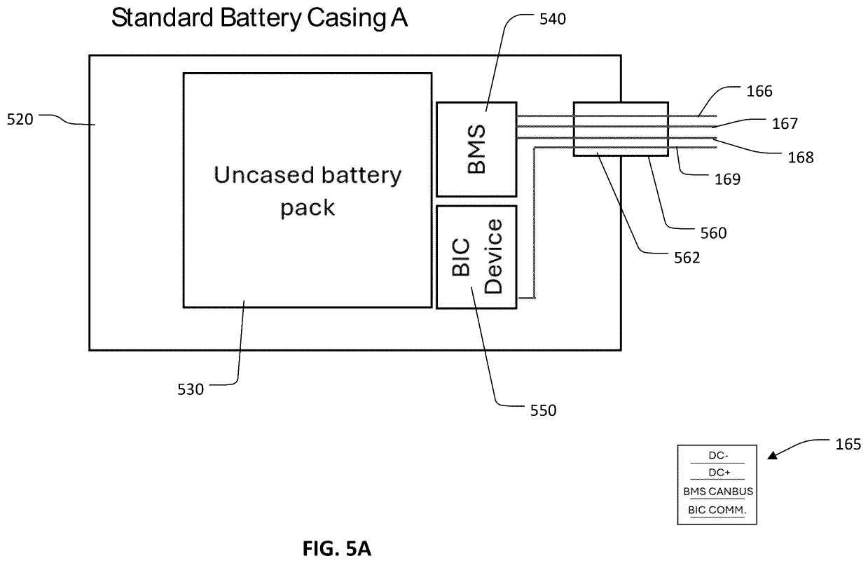

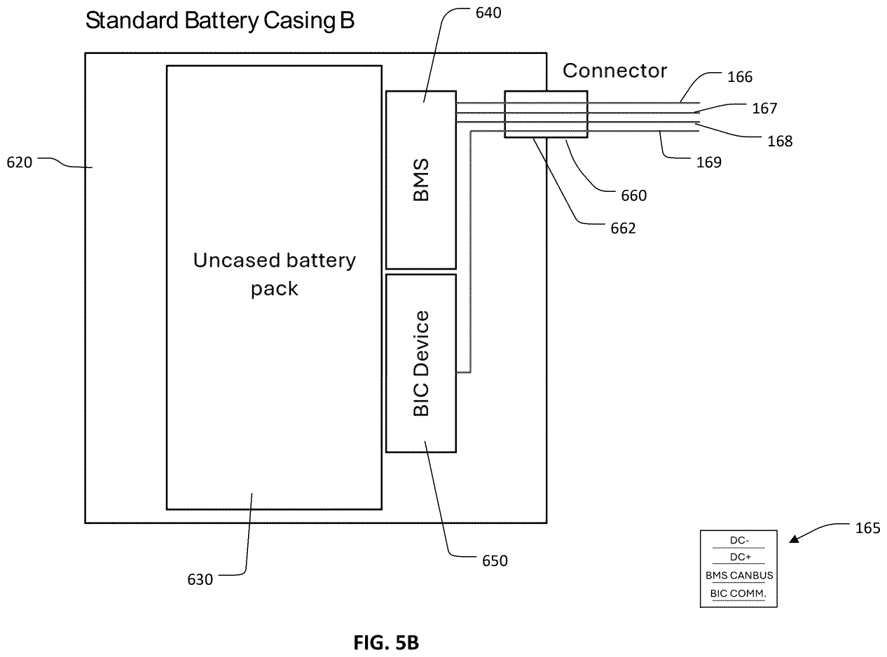

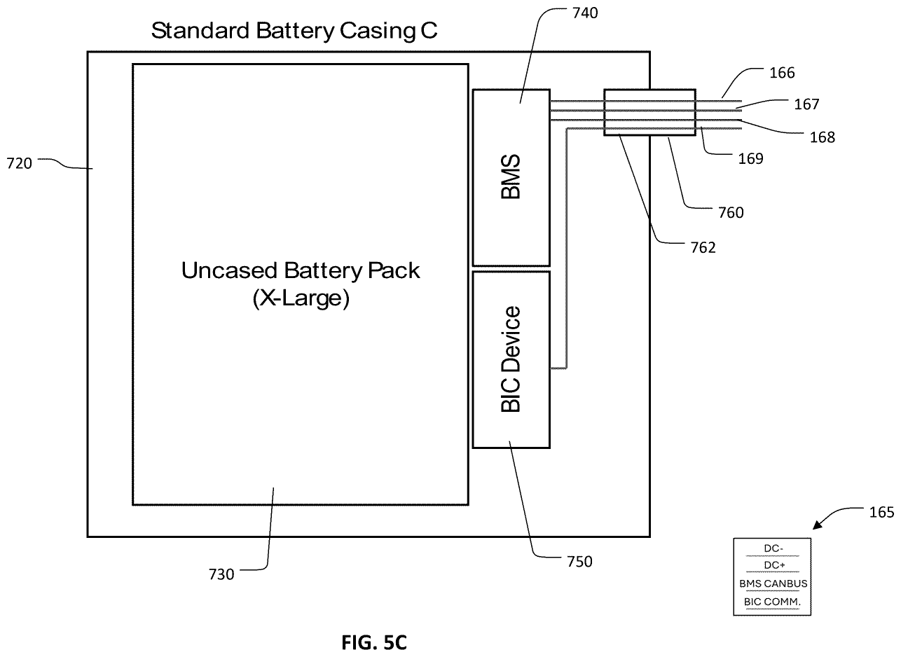

FIG. 5A is a schematic, top view of an example casing 520 including a battery 530, FIG. 5B is a schematic, top view of another example casing 620 including a battery 630, and FIG. 5C is a schematic, top view of yet another example casing 720 including a battery 730. As shown in FIGS. 5A to 5C, each casing 520, 620, 720 may be intentionally oversized to allow for various battery form factors while maintaining a final shape and size that is similar to or the same as each casing 520, 620, 720 held within the battery charging rack (e.g., battery charging rack 100). In some examples, the casings 520, 620, 720 may be different sizes, as illustrated in FIGS. 5A to 5C. Each casing 520, 620, 720 may include a varying size which may be based on capacity/voltage ranges of batteries 530, 630, 730, respectively, held therein. In such examples, the casings 520, 620, 720 having different sizes may require the use of differing connections, such as connections 560, 660, 760, respectively, and internally facing connections 562, 662, 762, respectively. The various sizes of connections 560, 660, 760, and internally facing connections 562, 662, 762, may serve to prevent type mismatch.

As shown in FIG. 5A, the casing 520 may include a smaller size configured to house the battery 530, which may be a small battery. The battery 530 may include a nominal charging voltage range of about 5 volts (V) to about 10 V, and a nominal capacity range of about 25-watt hours (Wh). The casing 620, as in FIG. 5B, may include a size configured to house the battery 630. The battery 630 may include a nominal charging voltage range of about 20 V to about 25 V, and a nominal capacity range of about 1 kilowatt hours (kWh). The casing 720, as in FIG. 5C, may include a size configured to house the battery 730. The battery 730 may include a nominal charging voltage range of about 50 V to about 60 V, and a nominal capacity range of about 500-watt hours (Wh). In other examples, the batteries 530, 630, 730 may vary in a nominal charging voltage range and/or the nominal capacity range. For example, any one of the batteries described herein may include a nominal charging voltage range of about 70 V to about 75 V, and a nominal capacity range of about 30-watt hours (Wh). In other examples, the nominal charging voltage range may be less than 5 V or greater than 75 V, and the nominal capacity range may be less than 30 Wh or greater than about 1 kWh. These are just examples.

In some examples, the batteries 130, 230, 330, 430a, 430b, 530, 630, 730 described herein may be from the same manufacturer. In other examples, the batteries 130, 230, 330, 430a, 430b, 530, 630, 730 described herein may not be from same manufacturer.

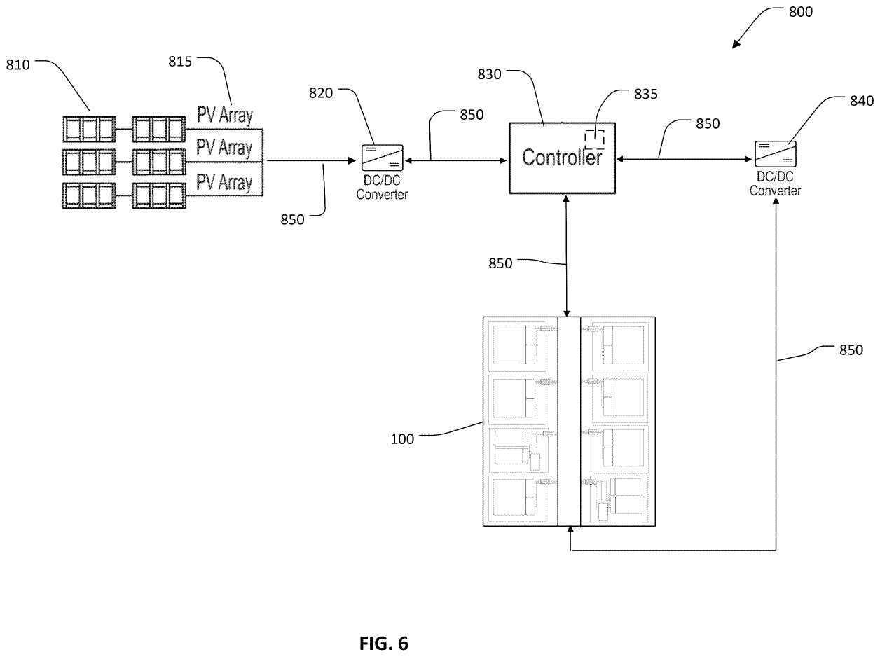

FIG. 6 is a schematic, block diagram illustrating a battery charging rack system 800, in accordance with the present disclosure. The battery charging rack system 800 may be utilized with the battery charging rack 100 described herein and may be configured to supply power to the battery charging rack 100. The battery charging rack system 800 may include a bi-directional DC/DC converter 820 that may be fed an output voltage from a first power source, such as a solar power plant 810. Other types of power sources may be contemplated such as steam, nuclear, geo-thermal, hydro-electric, wind, etc. It may be contemplated that two or more power sources can be utilized. The bi-directional DC/DC converter 820 may be sized for the output requirements of the grid to which it is connected. A common bus 850 may allow for near instantaneous response to changes in the system power requirements.

The battery charging rack system 800 may include a plurality of battery charging racks, although one battery charging rack 100 is shown in FIG. 6. The battery charging rack system 800 may further include a second bi-directional DC/DC converter 840, and a controller 830. The controller 830 can govern the charge and discharge rate. The bi-directional DC/DC converters 820, 840 may be configured to charge the battery charging rack 100. The bi-directional DC/DC converters 820, 840 may be sized to the battery output or input. Every battery charging rack 100 and bi-directional DC/DC converter 820, 840 may be separately managed. The bi-directional DC/DC converters 820, 840 may employ a power droop algorithm which maintains constant power output in a normal maximum power point tracking (MPPT) region. When the voltage is higher or lower than the MPPT region, a bi-directional DC/DC converter 820, 840 could ramp up power or ramp down power output to the common bus 850. Additionally, internal resistance of the parallel connected bi-directional DC/DC converters 820, 840 may maintain relatively equal current sharing between the battery charging racks 100 when multiple battery charging racks 100 are used. The power droop algorithm, in combination with the battery charging rack 100 and photovoltaic panel arrays 815 sharing a common bus 850 eliminates the need for additional communication and allows for a fast response to micro-grid applications.

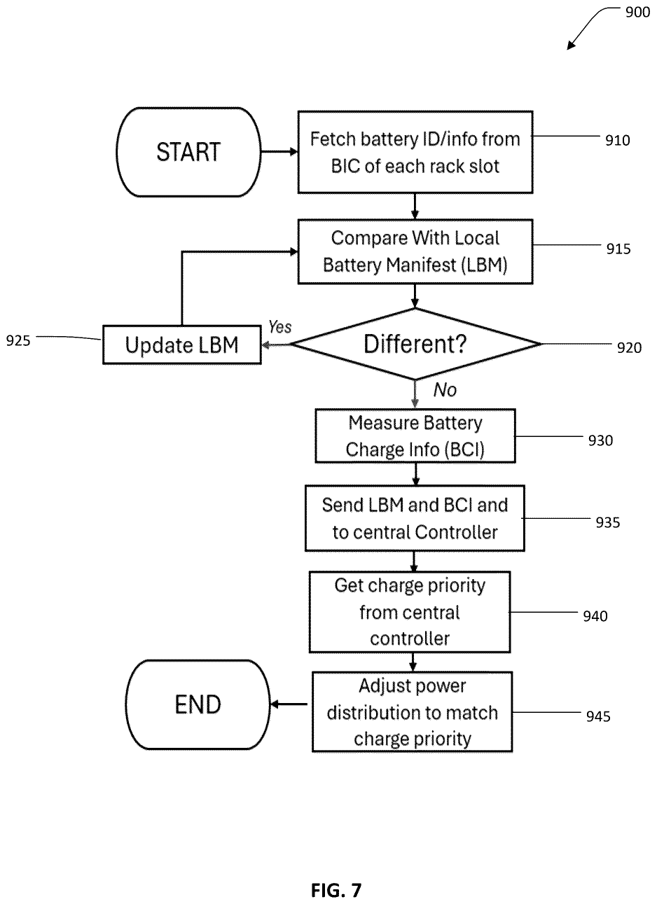

FIG. 7 is a flow chart illustrating a method 900 of charging batteries within a battery charging rack, in accordance with the present disclosure, such as battery charging rack 100 described herein. A BIC (e.g., BIC 150a, 250, 350, 450, 550, 650, 750) may check an onboard battery ID of each of the connected batteries, as referenced by block 910. The BIC may then compare the battery IDs with a local battery manifest (LBM), as referenced by block 915. The LBM is described elsewhere herein. If the onboard battery IDs are different 920 than the LBM, the BIC updates the LBM, as referenced by block 925. If the onboard batter IDs match those stored in the LBM, the BIC then measures the battery charge information, as referenced by block 930. The BIC then sends all information collected from the LBM, and battery charge information to a controller (e.g., controller 830 in FIG. 6), as referenced by block 935. Upon receiving the information regarding the LBM, and the battery charge information from the BIC, the controller then sends a charge schedule to the BIC, as referenced by block 940, and the BIC adjusts power distribution to each of the batteries (e.g., batteries 130, 230, 330, 430a, 430b, 530, 630, 730) to match the charge schedule sent by the controller, as referenced by block 945.

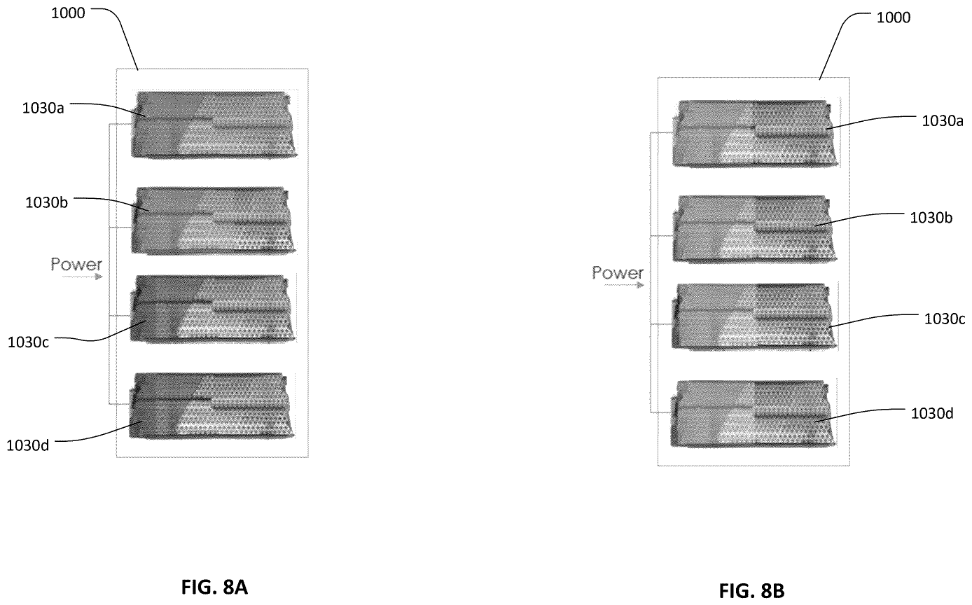

FIG. 8A depicts sequential charging of batteries within battery charging rack 1000, and FIG. 8B depicts simultaneous charging of batteries within the battery charging rack 1000. The battery charging rack 1000 may include a plurality of batteries 1030a, 1030b, 1030c, 1030d, generally referred to herein as batteries 1030. The batteries 1030 may be charged sequentially (FIG. 8A) or simultaneously (FIG. 8B), based on the shared state of charge of the whole battery charging rack 1000, and distribution of charge. When the batteries 1030 are charged simultaneously, charging will take a long time (e.g., 10 hours or greater) to reach full charge. However, when the batteries 1030 are charged sequentially, charging will allow for a few batteries 1030 to reach full charge quickly (e.g., about 1 hour), but may result in some system (e.g., battery charging rack 1000) performance cost.

Various non-limiting exemplary embodiments have been described. It will be appreciated that suitable alternatives are possible without departing from the scope of the examples described herein.

1. A system for charging repurposed batteries, the system comprising:
a plurality of casings, each casing being of consistent size and housing one or more batteries, each of the one or more batteries being uncased, whereby an original casing of the one or more batteries has been removed, each casing having externally facing connections of DC+, DC−, and one or more data communications links, the externally facing connections each coupled to internally facing connections to DC+, DC−, and one or more data communications links associated with the one or more batteries housed in such casing;
a battery charging rack having a plurality of compartments, each compartment being of complementary shape and size to hold one of the plurality of casings for charging the one or more batteries housed in such casing, each compartment having connections for DC+, DC−, and one or more data communications links positioned and shaped for interconnection with the DC+, DC−, and one or more data communications links of the one of the plurality of casings when held in such compartment, the battery charging rack having a common bus operatively coupled to the one or more communication links in each compartment for providing communication from each compartment to a controller, the battery charging rack selectively providing electrical voltage to the DC+ and DC− connections of select one or more compartments based on instructions from the controller.

2. The system of claim 1, wherein the one or more batteries housed in one of the plurality of casings have different manufacturers, different battery max voltages or different battery charging currents.

3. The system of claim 1, wherein each casing includes a battery management system to manage the one or more batteries housed in such casing.

4. The system of claim 3, wherein each casing includes a battery interface controller configured to store information about an associated one of the one or more batteries housed in the casing.

5. The system of claim 4, wherein the information stored by the battery interface controller includes one or more of: a battery manufacturer, a battery max voltage, and a battery current.

6. The system of claim 4, wherein the externally facing connection of the one or more data communications links of each casing is connected to both the battery management system and the battery interface controller, the battery interface controller configured to allow the battery management system to communicate directly with the battery charging rack via the one or more communication links of such casing.

7. The system of claim 4, wherein the battery management system and the battery interface controller are in series such that the battery management system connects through the battery interface controller to the externally facing connection of the one or more data communications links of each casing, the battery interface controller acting as a translator between the battery management system and the battery charging rack.

8. The system of claim 7, wherein the one or more batteries include a first battery and a second battery and the battery management system includes a first battery management system and a second battery management system, the first battery being associated with the first battery management system, and the second battery being associated with the second battery management system, the battery interface controller acting as a multiplexor to selectively transmit data between the first battery management system or the second battery management system and the externally facing connection of the more or more communication links of each case.

9. The system of claim 7, wherein the one or more batteries include a first battery and a second battery and the battery management system includes a first battery management system and a second battery management system, the first battery being associated with the first battery management system, and the second battery being associated with the second battery management system, each of the first battery management system and the second battery management system connected to the externally facing connection of the more or more communication links of each case.

10. The system of claim 1, wherein the one or more data communications links of the battery rack includes a battery management system CAN BUS communication link, and a battery interface controller communication link.

11. A method of repurposing rechargeable batteries, the method comprising:
removing a battery from an original casing of the battery;
placing the battery within a casing;
connecting a DC+, a DC−, and one or more data communications links of the battery to externally facing connections of DC+, DC−, and one or more data communications links of the casing;
placing the casing within a compartment of a battery charging rack, the compartment being of complementary shape and size of the casing;
communicating with the battery in the battery charging rack via the one or more data communication links of the casing to determine battery charge parameters; and
charging the battery via the charging rack in accordance with the determined battery charge parameters.
